(19) United States
(12) Patent Application Publication
(10) Pub. No.: US 2006/0227253 A1
(43) Pub. Date: Oct. 12, 2006

(54) Plasma display apparatus and driving method thereof

(76) Inventor: Nam Jin Kim, Seoul (KR)

Correspondence Address: MCKENNA LONG & ALDRIDGE LLP;Song K. Jung, 1900 K Street, N.W., Washington, DC, 20006, US

(21) Appl. No.: 11/304,598

(22) Filed: Dec. 16, 2005

(30) Foreign Application Priority Data
Apr. 7, 2005 (KR) 10-2005-0029173
Apr. 8, 2005 (KR) 10-2005-0029697

(51) Int. Cl. H04N 5/74; G02F 1/00; H04N 9/12; H04N 5/66

(52) U.S. Cl. 348/739; 348/755; 348/773

(57) ABSTRACT

There is provided a plasma display apparatus and a driving method of the plasma display apparatus. The plasma display apparatus comprises a plasma display panel comprising a scan electrode and a sustain electrode and a scan pulse controller for controlling a width of a scan pulse applied to the scan electrode in address period of a predetermined subfield of the subfield group to be wider than the width of a scan pulse of other subfield in the frame.

This Nonprovisional application claims priority under 35 U.S.C. §119(a) on Patent Application Nos. 10-2005-0029173 and 10-2005-0029697 filed in Korea on Apr. 7, 2005 and Apr. 8, 2005 the entire contents of which are hereby incorporated by reference.

### BACKGROUND OF THE INVENTION

1. Field of the Invention

The present invention relates to a plasma display apparatus.

### DESCRIPTION OF THE BACKGROUND ART

Generally, in a plasma display panel, barrier ribs are formed between a front panel and a rear panel to constitute a unit cell and an inert gas containing a main discharge gas such as Neon (Ne), Helium (He), or mixing gas (Ne+He) of Neon and Helium, and a small quantity of xenon is contained within each cell. When a discharge is performed by a high frequency voltage, the inert gas generates vacuum ultraviolet rays and allows a phosphor formed between the barrier ribs to emit light and thus a portion of image is created. Such a plasma display panel is manufactured to be thin and light weight, and, as such is considered one of the next generation display devices.

FIG. 1 illustrates a structure of a general plasma display panel.

As shown in FIG. 1, in the plasma display panel, a front panel 100 is arranged with a plurality of sustain electrode pairs formed in a pair of a scan electrode 102 and a sustain electrode 103 in a front glass, that is, a display surface in which an image is displayed and a rear panel 100 in which a plurality of address electrodes 113 is arranged to intersect the plurality of sustain electrode pairs on a rear glass forming a rear surface are coupled to each other in parallel and are separated by a fixed distance.

The front panel 100 is discharged to each other in one discharge cell and includes pairs of scan electrode 102 and sustain electrode 103 for maintaining the light emitting capabilities of a cell, that is, scan electrode 102 and sustain electrode 103 having a transparent electrode (a) made of a transparent ITO material and a bus electrode (b) made of a metal material. Scan electrode 102 and sustain electrode 103 prevent a discharge current from flowing and are covered with one or more upper dielectric layer 104 for isolating electrode pairs, and a protective layer 105 evaporated with a magnesium oxide (MgO) is formed on a top surface of the upper dielectric layer 104 to facilitate a discharge condition.

In rear panel 110, a stripe type (or well type) barrier rib 112 for forming a plurality of discharge spaces, that is, a discharge cell are arranged in parallel. A plurality of address electrodes 113 for generating vacuum ultraviolet rays by performing address discharge are arranged in parallel with the barrier rib 112. A RGB phosphor 114 emitting visible rays for displaying an image at address discharge is coated on the upper surface of the rear panel 110. A lower dielectric layer 115 for protecting the address electrode 113 between the address electrode 113 and the phosphor 114 is formed.

A method of embodying an image gray level in a plasma display panel described above will be described with reference to FIG. 2.

FIG. 2 is a diagram illustrating a method embodying an image gray level of a conventional plasma display panel.

As shown in FIG. 2, in a method for expressing an image gray level on a conventional plasma display panel, one frame is divided into several subfield, each subfield having a different number of light emitting. Each subfield is again divided into a reset period (RPD) for initializing all cells, an address period (APD) for selecting a cell to be discharged, and a sustain period (SPD) for embodying a gray level depending on the number of discharges. For example, when an image is displayed with 256 gray levels, a frame period (16.67 ms) corresponding to 1/60 second is divided into 8 subfields (SF1 to SF8) as in FIG. 2, and each of the 8 subfields (SF1 to SF8) is again divided into a reset period, an address period, and a sustain period.

The reset period and the address period of each subfield are equal in each subfield. The address discharge for selecting a cell to be discharged occurs due to a voltage difference between the address electrode and a transparent electrode that is a scan electrode. The sustain period is increased with a ratio of 2ⁿ (n=0, 1, 2, 3, 4, 5, 6, 7) in each subfield. Because the sustain period is different in each subfield, an image gray level is expressed by adjusting the sustain period of each subfield, that is, the number of the sustain discharges.

A driving waveform depending on the method of driving the plasma display panel is shown in FIG. 3.

FIG. 3 is a diagram illustrating an example of a driving waveform according to a method of driving a conventional plasma display panel.

As shown in FIG. 3, the plasma display panel is driven by dividing into a reset period for initializing all cells, an address period for selecting a cell to be discharged, a sustain period for maintaining the discharge of the selected cell, and an erasing period for erasing wall charges within the discharged cell.

During a reset period, in a setup period, a ramp-up waveform is simultaneously applied to all scan electrodes. A weak dark discharge occurs within the discharge cells of an entire screen by the ramp-up waveform. Positive polarity wall charges are stacked on an address electrode and a sustain electrode and negative polarity wall charges are stacked on a scan electrode, by means of a setup discharge.

In a setdown period, after a ramp-up waveform is supplied, a falling ramp-down waveform dropping from a positive polarity voltage lower than a peak voltage of the ramp-up waveform to a specific voltage level of a ground (GND) level voltage or less causes weak erasing discharge within cells, thereby fully erasing wall charges excessively formed on a scan electrode.

Wall charges to stably cause the address discharge by means of the setdown discharge evenly remain within cells.

In the address period, a negative polarity scan pulse is sequentially applied to the scan electrodes and is simultaneously synchronized with another scan pulse and thus a positive polarity data pulse is applied to the address electrode.

As the voltage difference between the scan pulse and the data pulse is added to the wall voltage generated in the reset period, an address discharge occurs within the discharge cell to which data pulse is applied. Wall charges to generate a-discharge when a sustain voltage (Vs) is applied are formed within cells selected by an address discharge. A positive polarity voltage (Vz) supplied to the sustain electrode prevents an erroneous discharge within the scan electrode by reducing the voltage difference within scan electrode during the setdown period and the address period.

In the sustain period, a sustain pulse (Sus) is alternatively applied to a scan electrode and a sustain electrode. A wall voltage within a cell and a sustain pulse are added to the cell selected by the address discharge and thus the sustain discharge, that is, the display discharge occurs between the scan electrode and the sustain electrode whenever each sustain pulse is applied.

After the sustain discharge is completed, in the erasing period, a voltage of ramp-ers having narrow pulse width and low voltage level is supplied to the sustain electrode, thereby erasing wall charges remaining within cell of an entire screen.

In the plasma display panel driven by a the driving waveform, the widths of the scan pulses (Vsc) applied to the scan electrode in the address period in a subfield of all frames are equal in all subfields. Widths of these conventional scan pulses are shown in FIG. 4.

FIG. 4 is a diagram illustrating the width of a scan pulse applied in an address period in a method of driving a conventional plasma display panel.

As shown in FIG. 4, the width of the scan pulse applied in the address period in a method of driving of a conventional plasma display panel is set to be equal to W in all subfields. In other words, the widths of the scan pulses are equal to each other in a subfield embodying a low gray level because of having a relatively low weight and a subfield embodying a high gray level because of having a relatively high weight.

The width of the scan pulse applied to the scan electrode in the above-mentioned address period is one among many factors to influence the generation of a wall charge within a discharge cell. As the width of the scan pulse (Vsc) falling in antipolarity is increased from a scan reference voltage rising from the end of the setdown pulse, a continued time of address discharge is increased and thus much more wall charges are generated within the discharge cell.

However, because in the conventional method all widths of all scan pulses are set to be equal in all subfields regardless of weight, that is, a gray level value, address discharges may become unstable in an initial subfield, that is, a subfield having a relatively low gray level value. Therefore, address jitter increases because is deteriorated.

The address discharge is unstable in a subfield embodying a low gray level because the low gray level has a relatively low weight and because the number of sustain pulses is lower, compared to a subfield embodying a high gray level. Accordingly, there is a possibility that a sustain discharge will become unstable because the amount of wall charges stacked within the discharge cell is insufficient to perform the sustain discharge due to an unstable address discharge. Considering the characteristics of a sustain discharge, the distribution of wall charges within a discharge cell should be set to be advantageous in the sustain discharge by generating stable address discharge in the address period. However, because in the conventional method the widths of all scan pulses are set to be equal in-all subfields regardless of weight, that is, the gray level value, the distribution of wall charges within the discharge cells after the address discharge is not enough in an initial subfield, that is, a subfield having a relatively low gray level value having a high possibility that the address discharge may become unstable, whereby there is a problem in that the subsequent sustain discharge becomes unstable or is not generated.

Flicker is generated in the plasma display panel driven in a driving waveform as shown in FIG. 3.

This flicker is generally generated when the length of time of a phosphor is shorter than the vertical frequency (frame frequency) of a video signal. For example, if the vertical frequency is 60 Hz, an image of one frame per 16.67 m/sec is displayed, but because the reaction velocity of the phosphor is faster than this velocity, flicker, blinking of the screen, is generated.

In a phase alternating line (PAL) mode, because the vertical frequency is 50 Hz, the problem frequently occurs.

In the PAL mode, flicker is reduced because arrangement of subfields is performed in a plurality of steps within one frame.

The arrangement of the subfields in the PAL mode is shown in FIG. 5.

FIG. 5 is a diagram illustrating the arrangement of subfields for creating an image in a plasma display panel using a conventional PAL method.

Referring to FIG. 5, using a conventional PAL mode, subfields of different weights are divided into plural, particularly, two groups within one frame.

For example, as in FIG. 5, a subfield of weight 1, that is, a gray level value 1, a subfield of weight 8, a subfield of weight 16, a subfield of weight 32, and a subfield of weight 64 are included in the first subfield group.

Further, a subfield of weight 2, a subfield of weight 4, two subfields of weight 8, a subfield of weight 16, a subfield of weight 32, and a subfield of weight 64 are included in the second subfield group.

A sum of the weights of the subfields within one frame arranged as described above, that is, a sum of gray level value is 1+2+4+8+(8+8)+(16+16)+(32+32)+(64+64)=255. As a result, 256 gray levels can be embodied.

In a conventional PAL mode for driving a plasma display panel by arranging subfields into a plurality of steps within one frame, flicker is reduced, but there is a problem that the number of subfields having a relatively low weight increases, that is, the low gray level value within one frame increases.

In a general mode in which the arrangement of the subfield is 1 step within one frame, as in FIG. 2, if a subfield has a relatively low weight, that is, the low gray level value is divided into the first, second, third, fourth subfields having a gray level value of 1, 2, 4, 8, in the PAL mode in which arrangement of the subfield is two steps within one frame, subfields having the relatively low weight, value are the first and second subfields in the first subfield group and are the first, second, third, fourth subfields in the second subfield group.

Accordingly, in the conventional PAL mode, because the number of subfields having a relatively low weight, that is, low gray level value increases, compared to a general mode in which the arrangement of the subfield is 1 step within one frame, in an initial subfield, that is, a subfield having the low gray level value having a high possibility that address discharge may become unstable, because the distribution of wall charges is not enough within the discharge cell after the address discharge, a problem arises in that the subsequent sustain discharge becomes unstable or the sustain discharge is not generated deepened.

### SUMMARY OF THE INVENTION

Accordingly, an object of the present invention is to solve at least the problems and disadvantages of the background art.

An objection of the present invention is to provide a plasma display apparatus which can stabilize address discharge and sustain discharge by reducing generating of a flicker and adjusting a scan pulse width.

To achieve these and other advantages and in accordance with the purpose of the present invention, as embodied and broadly described, there is provided a plasma display apparatus comprising: a plasma display panel having a scan electrode; a scan pulse controller for controlling a width of a scan pulse applied to the scan electrode in address period of a predetermined subfield of a subfield group to be wider than the width of a scan pulse of other subfield in the frame.

According to the present invention, it is possible to reduce generating of a flicker in a PAL driving method.

According to the present invention, it is possible to stabilize address discharge and sustain discharge by adjusting a scan pulse width.

### BRIEF DESCRIPTION OF THE DRAWINGS

The invention will be described in detail with reference to the following drawings in which like numerals refer to like elements.

FIG. 1 illustrates the structure of a conventional plasma display panel;

FIG. 2 is a diagram illustrating a method creating an image gray level of a conventional plasma display panel;

FIG. 3 is a diagram illustrating an example of a driving waveform according to a driving method of a conventional plasma display panel;

FIG. 4 is a diagram illustrating the width of a scan pulse applied in an address period in a method of driving a conventional plasma display panel;

FIG. 5 is a diagram illustrating the arrangement of subfields for creating an image in a plasma display panel using a conventional PAL method;

FIG. 6 is a diagram illustrating a plasma display apparatus according to the present invention;

FIGS. 7a and 7b are diagrams illustrating an example in which one frame is divided into a plurality of subfield groups;

FIG. 8 is a diagram illustrating a driving waveform according to the first embodiment of a method of driving a plasma display panel of the present invention;

FIG. 9 is a diagram illustrating an example in which one frame is divided into a plurality of subfield groups and a subfield group is selected from the subfield groups;

FIG. 10 is a diagram illustrating the width of a scan pulse according to the first embodiment of a method of driving a plasma display-panel of the present invention;

FIGS. 11a to 11b are diagrams illustrating the relationship of the width of a scan pulse between subfields adjusting a width of a scan pulse applied to a scan electrode in an address period to be a first critical time or more;

FIGS. 12a to 12b are diagrams illustrating another example in which one frame is divided into a plurality of subfield groups;

FIG. 13 is a diagram illustrating a driving waveform according to a second embodiment of a method of driving a plasma display panel of the present invention;

FIG. 14 is a diagram illustrating another example in which one frame is divided into a plurality of subfield groups and in which a subfield group is selected from the subfield groups;

FIG. 15 is a diagram illustrating the width of a scan pulse according to the second embodiment of a method of driving a plasma display panel of the present invention;

FIGS. 16a to 16b are diagrams illustrating another relationship of the width of a scan pulse between subfields adjusting a width of a scan pulse applied to a scan electrode in an address period to be a first critical time or more;

FIGS. 17a to 17b are diagrams illustrating a third embodiment of a method of driving a plasma display panel of the present invention; and

FIGS. 18a to 18b are diagrams illustrating a fourth embodiment of a method of driving a plasma display panel of the present invention.

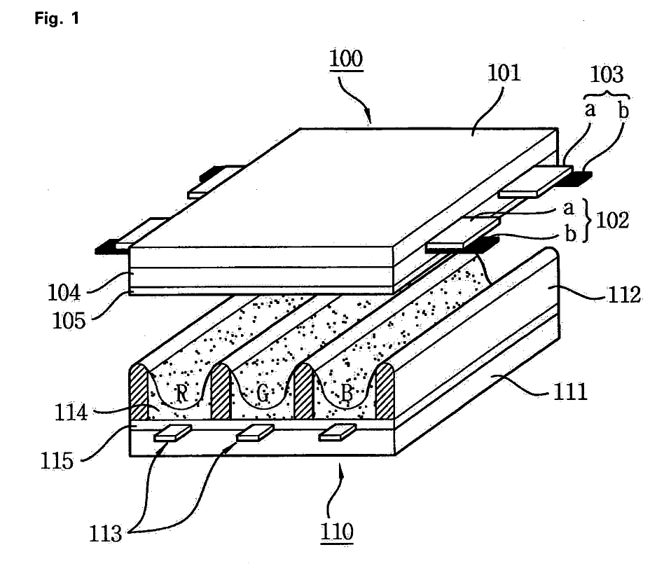

### DETAILED DESCRIPTION OF PREFERRED EMBODIMENTS

Preferred embodiments of the present invention will be described in a more detailed manner with reference to the drawings.

According to an aspect of the present invention, there is provided plasma display apparatus comprises a plasma display panel comprising a scan electrode and a sustain electrode and a scan pulse controller for controlling a width of a scan pulse applied to the scan electrode in address period of a predetermined subfield of the subfield group to be wider than the width of a scan pulse of other subfield in the frame.

An idle period having a predetermined length is between frames and subfield groups of the frame is continuously arranged within the same frame.

A first idle period having a predetermined length is included between frames and a second idle period having a predetermined length is further included between the subfield groups within the same frame.

Lengths of the first idle period and the second idle period are the same.

The plurality of subfield groups include a plurality of subfields and the plurality of subfield groups are arranged in the increasing order of a gray level value of subfields within each group.

The plurality of subfield groups include a plurality of subfields and the plurality of subfield groups are arranged in the decreasing order of a gray level value of subfields within each group.

The frame is divided into two subfield groups, each of two subfield groups includes a plurality of subfields, the two subfield groups are arranged in the size order of a different gray level value of subfields within each subfield group.

Any one of the two subfield groups is arranged in the increasing order of a gray level value of subfields within each group.

Any one of the two subfield groups is arranged in the decreasing order of a gray level value of subfields within each group.

Any one of the two subfield groups is arranged in the decreasing order of a gray level value of subfields within each group and the other one of the two subfield groups is arranged in the increasing order of a gray level value of subfields within each group.

The scan pulse controller sets the width of a scan pulse to be a first critical time or more in a subfield in which a width of the scan pulse applied to the scan electrode is wider than the width of the scan pulse of other subfield in the address period.

The first critical time is 2.0 μs.

The width of a scan pulse applied to the scan electrode in the address period in one and more subfield is equal to or more than the first critical time.

The width of a scan pulse applied to the scan electrode in the address period in one and more subfield in each subfield group is equal to or more than the first critical time.

The width of a scan pulse applied to the scan electrode in the address period is equal to or more than the first critical time in subfields from the lowest gray level subfield to a predetermined number of subfields in ascending order of a gray level.

The width of a scan pulse applied to the scan electrode in any subfield of three low gray level subfields is wider than the width of a scan pulse applied to the scan electrode other subfields.

The subfield are plural in which the width of the scan pulse is equal to or more than the first critical time, the scan pulse controller sets a width of the scan pulse applied to the scan electrode in the address period of one subfield of the plurality of subfields to be different from a width of the scan pulse applied to the scan electrode in the address period of other subfields of the plurality of subfields.

The subfield are plural in which the width of the scan pulse is equal to or more than the first critical time, the scan pulse controller sets a width of the scan pulse applied to the scan electrode in the address period to be different from a width of the scan pulse applied to the scan electrode in the address period of each subfield of the plurality of subfields.

The scan pulse controller increases a width of a scan pulse applied to the scan electrode in the address period as a gray level in any subfield of the plurality of subfields decreases.

The subfield in which the width of the scan pulse is equal to or more than the first critical time uses sustain pulses equal to or less than the critical number.

The critical number is 50% or less than the number of total sustain pulses used in one frame.

The critical number is 30% or less than the number of total sustain pulses used in one frame.

The scan pulse controller sets the width of the scan pulse applied to the scan electrode in the address period to be the second critical time or less in the other subfield except a subfield in which the width of the scan pulse applied to the scan electrode in the address period is the first critical time or more.

The second critical time is ½ of the first critical time.

The second critical time is 1.5 μs.

Hereinafter, exemplary embodiments of the present invention will be described in detail with reference to the accompanying drawings.

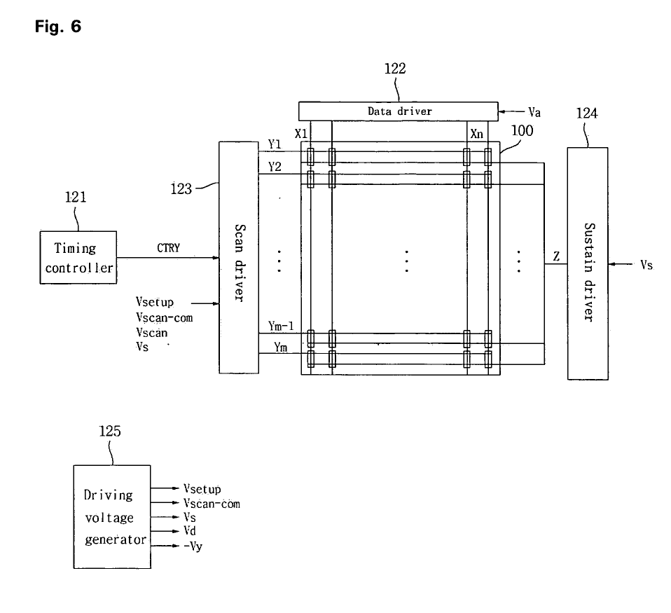

FIG. 6 is a diagram illustrating a plasma display apparatus according to the present invention.

As shown in FIG. 6, a plasma display apparatus according to the present invention comprises a scan electrode (Y1 to Yn) and a sustain electrode (Z) and a plurality of address electrodes (X1 to Xm) intersecting the scan electrode and the sustain electrode (Z) and comprises a plasma display panel 100 expressing an image comprising a frame by at least one subfield combination in which a driving pulse is applied to the address electrode (X1 to Xm), the scan electrode (Y1 to Yn), and the sustain electrode (Z) in a reset period, an address period, and a sustain period, a data driver 122 supplying data to the address electrode (X1 to Xm) formed in the plasma display panel 100, a scan driver 123 driving the scan electrode (Y1 to Yn), a sustain driver 124 driving the sustain electrode (Z) that is a common electrode, a scan pulse controller 121 controlling the scan driver 123 when the plasma display panel 100 is driven, and a driving voltage generator 125 supplying a driving voltage required to each driver 122, 123, and 124.

The plasma display apparatus according to the present invention expresses an image comprising a frame by at least one subfield combination in which the driving pulse is applied to the address electrode, the scan electrode, and the sustain electrode in the reset period, the address period, and the sustain period and adjusts the width of the scan pulse applied to the scan electrode (Y1 to Yn) is adjusted to be larger than that of another subfields in an address period of at least one subfield in at least one subfield group among a plurality of subfield groups by dividing one frame into a plurality of subfield groups and controlling each driver 122, 123, and 124 in a plurality of subfield groups. A reason for adjusting the width of the scan pulse will be described in detail below.

In the plasma display panel 100, the front panel (not shown) and the rear panel (not shown) are coupled to each other separated by a fixed interval. Many electrodes, for example, the scan electrodes (Y1 to Yn) and the sustain electrode (Z) are formed in pairs, and address electrodes (X1 to Xm) are formed to intersect the scan electrodes (Y1 to Yn) and the sustain electrode (Z).

In the data driver 122, after a reverse gamma correction and an error diffusion are performed by a reverse gamma correction circuit and an error diffusion circuit which are not shown, mapped data is supplied to each subfield by a subfield mapping circuit. After the data driver 122 samples and latches the data in response to a data timing control signal (CTRX) from a timing controller (not shown), it supplies the data to the address electrodes (X1 to Xm).

The scan driver 123 supplies a ramp-up waveform and a ramp-down waveform to the scan electrodes (Y1 to Yn) during a reset period under the control of the scan pulse controller 121. The scan driver 123 sequentially supplies a scan pulse (Sp) of a scan voltage (−Vy) to the scan electrodes (Y1 to Yn) during the address period under the control of the scan pulse controller 121 and supplies the sustain pulse (sus) to the scan electrodes (Y1 to Yn) during the sustain period.

The sustain driver 124 supplies a bias voltage of a sustain voltage (Vs) to the sustain electrodes (Z) during the address period and a period in which a ramp-down waveform is generated under the control of a timing controller (not shown). The sustain driver 124 also supplies the sustain pulse (sus) to the sustain electrodes (Z) by alternately operating with the scan driver 123 during the sustain period.

The scan pulse controller 121 generates a timing control signal (CTRY) for controlling the operation timing and synchronization of the scan driver 123 and for controlling the scan driver 123 in the reset period, the address period, and the sustain period and for supplying the timing control signal (CTRY) to the scan driver 123 so as to control the scan driver 123. For example, if a frame is divided into a plurality of subfield groups, the scan driver 121 allows the width of the scan pulse applied to the scan electrode (Y1 to Yn) to be wider than that of other subfields in an address period of at least one subfield in at least one subfield group among a plurality of subfield groups by controlling the scan driver 123 in the divided plurality of subfield groups. In particular, a control signal is supplied to the scan driver 123 to control the width of the scan pulse applied to the scan electrode in the address period in a subfield with a low gray level because of a relatively low weight, that is, a relatively low gray level value to be larger than that of other subfield.

When the plasma display panel 100 is driven by dividing it into a plurality of subfields, a gray level is expressed with a brightness weight in each subfield. A low gray level means a gray level value in a subfield having a relatively low brightness weight at this time.

A data control signal (CTRX) comprise a switch control signal for controlling the on/off time of a sampling clock for sampling data, a latch control signal, an energy recovery circuit, and a driving switch element is included in the data control signal (CTRX). A switch control signal for controlling an on/off time of the driving switch element and the energy recovery circuit within the scan driver 123. A sustain control signal (CTRZ) comprise a switch control signal for controlling the on/off time of the driving switch element and the energy recovery circuit within a sustain driver.

The driving voltage generator 125 generates a setup voltage (Vsetup), a scan common voltage (Vscan-com), a scan voltage (−Vy), a sustain voltage (Vs), and a data voltage (Vd), etc. These driving voltages will change depending on a composition of the discharge gas or the structure of a discharge cell.

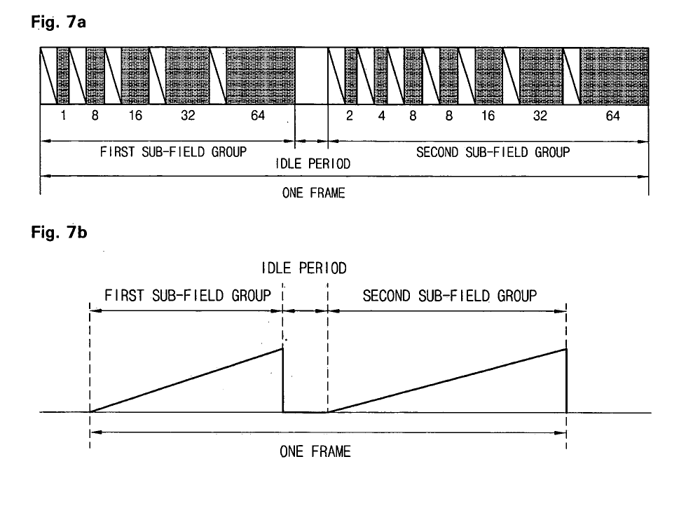

A driving method performed by the plasma display apparatus of the present invention comprise dividing one frame into a plurality of subfield groups and allowing the width of the scan pulse applied to the scan electrode (Y1 to Yn) to be wider than that of other subfields in an address period of any one subfield from such divided subfield group. An example of a subfield arrangement having a plurality of steps within one frame will be described with reference to FIG. 7a and 7b.

FIGS. 7a and 7b are diagrams illustrating an example in which one frame is divided into a plurality of subfield groups.

As shown in FIGS. 7a and 7b, one frame is divided into two subfield groups, for example, two subfield groups, that is, a first subfield group and a second subfield group as shown in FIG. 7a. The subfields are arranged in two steps.

Referring to FIG. 7a, an idle period having a predetermined length is included between the first subfield and the second subfield.

The subfields are arranged according to increasing order of weight, that is, a gray level value within the first subfield group and the second subfield group. A subfield having the lowest weight of the subfield, that is, the lowest gray level value, is positioned at an initial position of each subfield group and then the subfield having the next gradually higher weight is positioned.

For example, a subfield of weight 1(a gray level value 1), a subfield of weight 8(a subfield of weight 16), a subfield of weight 32(a subfield of weight 64) are included in lowest to highest weight/gray level order in the first subfield group. A subfield of weight 2(a gray level value 2), a subfield of weight 4, two subfields of weight 8, a subfield of weight 16, a subfield of weight 32, and a subfield of weight 64 is included in lowest to highest weight/gray level order in the second subfield group.

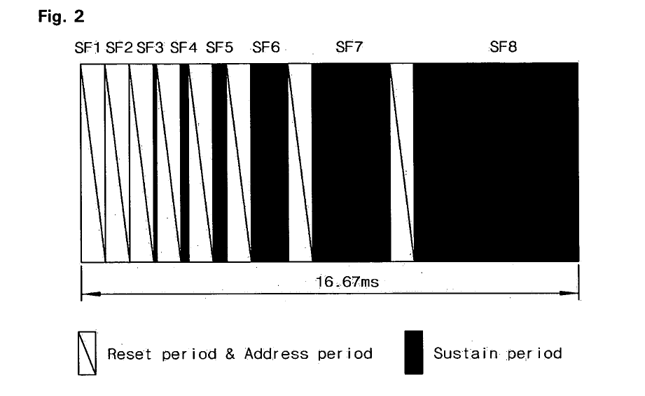

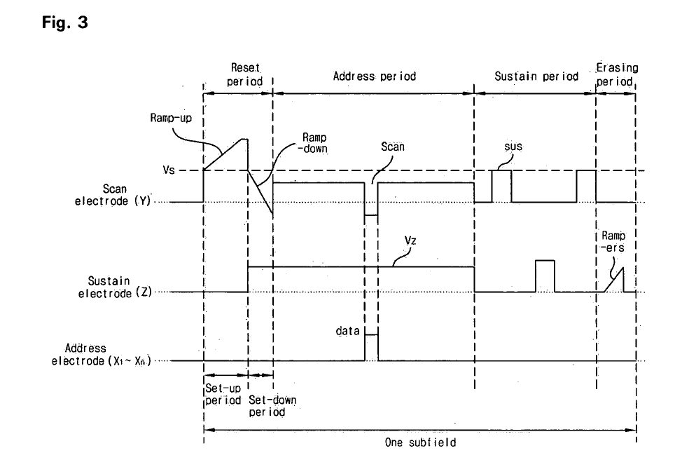

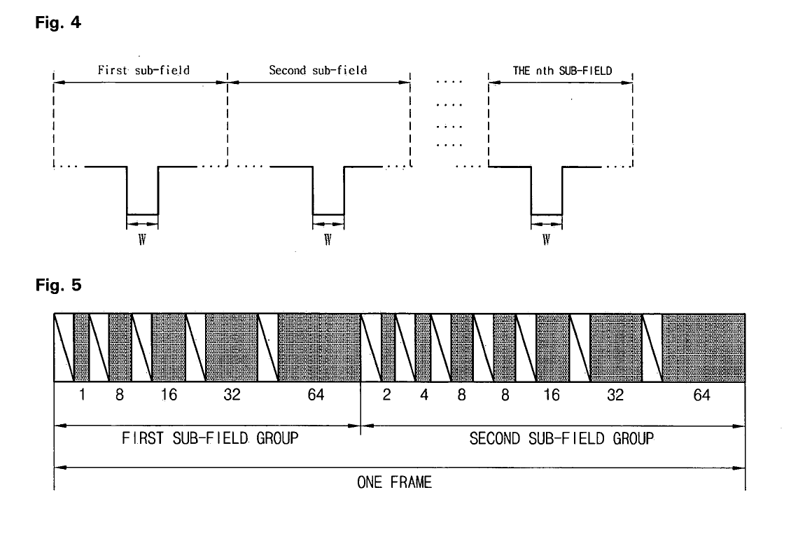

A sum of the weight of the subfield within one frame as arranged above is 1+2+4+8+(8+8)+(16+16)+(32+32)+(64+64)=255. 256 gray levels in the frame shown in. FIG. 2 in which a subfield having a weight of 1, 2, 4, 8, 16, 32, 64, 128 is arranged in the order can be embodied. The first subfield group which can embody 121 gray levels and the second subfield group which can embody 135 gray levels are included and thus an effect of two frames embodying gray levels of 121 and 135 can be obtained. Accordingly, flicker is reduced. A concept on a weight of the subfield and a concept on an idle period in one such frame are shown in FIG. 7b.

As shown in FIG. 7b, the first subfield group and the second subfield group are included in one frame and the idle period is included between these subfield groups. Note that the weight of the subfield included in each subfield group is shown in a triangle shape. The triangle shape means that the subfields are arranged according to the increasing order of a weight, that is, a gray level value within each subfield.

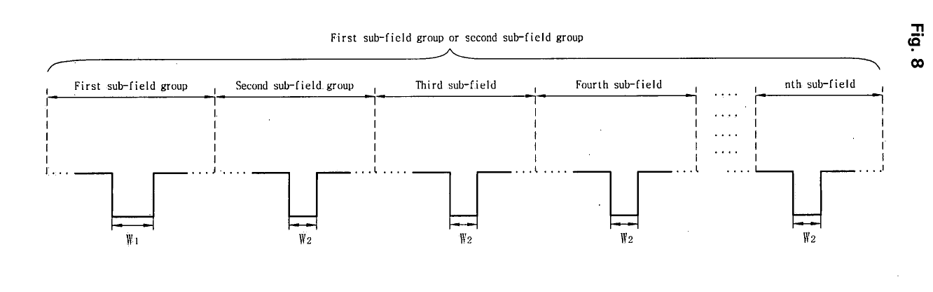

In a mode in which one frame is driven by dividing into a plurality of subfield groups, the width of a scan pulse is adjusted in one subfield having a low weight/low gray level value. The scan pulse adjusted by the driving method is shown in FIG. 8.

FIG. 8 is a diagram illustrating a driving waveform according to the first embodiment of a method of driving the plasma display panel of the present invention.

As shown in FIG. 8, in a driving waveform according to a method of driving a plasma display panel of the present invention which comprises the scan electrodes (Y1 to Yn) and the sustain electrode (Z) and a plurality of address electrodes (X1 to Xm) intersecting the scan electrode and the sustain electrode and expresses an image consisting of a frame by at least one subfield combination in which a driving pulse is applied to the address electrode, the scan electrode, and the sustain electrode in the reset period, the address period, and the sustain period, ifa frame is divided into a plurality of subfield groups, a width of a scan pulse applied to the scan electrode (Y1 to Yn) is wider than that of other subfields in an address period of at least one subfield in at least one subfield group among the plurality of subfield groups.

For example, as shown in FIG. 8, if the width of the scan pulse applied to the scan electrode in the address period in a first subfield having a low weight/low gray level value within the first subfield group or the second subfield group is W1 and the width of the scan pulse at the subsequent subfield, that is, from the second subfield to the nth subfield is W2, W1 is wider than W2.

As described above, a subfield group in which the width of the scan pulse applied to the scan electrode in the address period in a subfield having a low weight/low gray level value is wider than that of other subfields may be all subfield groups within one frame, or a plurality of subfields or any one subfield selected within one frame. For example, as shown in FIG. 8, when one frame is divided into a first subfield group and a second subfield group, the width of the scan pulse applied to the scan electrode in the address period in a subfield having a low weight/low gray level value in the first subfield group may be wider than that of other subfields. Even in the second subfield group, the width of the scan pulse applied to the scan electrode in the address period in a subfield having a low weight/low gray level value may be larger than that of other subfield or in only one among the first subfield group or the second subfield group, the width of the scan pulse applied to the scan electrode in the address period in a subfield having a low weight/low gray level value may be wider than that of other subfields.

As described above, the width of the scan pulse, that is, W1 has a length of the first critical time or more in a subfield in which the width of the scan pulse applied to the scan electrode (Y1 to Yn) in the address period is wider than that of other subfields.

A width W2 of the scan pulse applied to the scan electrode (Y1 to Yn) in the address period has a length of the second critical time or less in other subfields except a subfield in which a width of the scan pulse applied to the scan electrode (Y1 to Yn) in the address period is the first critical time or more.

Preferably, the second critical time is 1.5 μs and thus W2 is 1.5 μs or less. As shown in FIG. 8, the width of the scan pulse applied to the scan electrode in the address period in other subfields except the first subfield within the first subfield group or the second subfield group is 1.5 μs or less.

The reason why the width of the scan pulse applied to the scan electrode in the address period of the other subfields except a subfield in which the width of the scan pulse applied to the scan electrode (Y1 to Yn) in the address period in the first subfield group and the second subfield group into which one frame is divided larger than the first critical time is set to 1.5 μs or less is that an extended graphic array (XGA) panel has significantly more discharge cells than a video graphic array (VGA) when the extended graphic array (XGA) panel is embodied to create an image quality of a high definition (HD) grade. That is, the width of the scan pulse is set to 1.5 μs or less to address all of relatively many discharge cells within the limited address period. If the scan pulse width exceeds 1.5 μs, the length of an entire address period is prolonged and thus the length of the sustain period decreases. Therefore, the number of the sustain pulses applied in the sustain period decreases, thereby decreasing the absolute brightness of the plasma display panel. Accordingly, the width of the scan pulse applied in the address period of the other subfields except a subfield in which the width of the scan pulse applied to the scan electrode (Y1 to Yn) in the address period is the first critical time or more will be adjusted to 1.5 μs or less.

When the width W1 of the scan pulse applied to the scan electrode in the address period is the first critical time or more as in the first subfield shown in FIG. 8, it is preferable that the first critical time is two times longer than the second critical time. That is, the second critical time is ½ the time of the first critical time. Preferably, the second critical time is 1.5 μs or more.

Because a subfield in which the width of the scan pulse applied to the scan electrode is the first critical time or more in the address period in each subfield group, that is, the first subfield group and the second subfield group have a relatively low weight, it is preferable that the subfield embodies a low gray level.

The reason why the width of the scan pulse applied to the scan electrode in the address period of any one subfield, more preferably, a subfield having a low weight/low gray level value is adjusted to be the first critical time or more in each subfield group, that is, the first subfield group and the second subfield group is to stabilize address discharge in the subfield having a low weight/gray level value. That is, as describe above, because a possibility that the address discharge may be unstable is higher than other subfield, that is, a subfield embodying a high gray level due to the relatively high weight in a subfield embodying a low gray level due to the relatively low weight, the address discharge is stabilized by setting a width of the scan pulse applied to the scan electrode in the address period of the subfield having a low weight/low gray level value to be the first critical time or more. Accordingly, an address jitter improves and the sustain discharge in the subsequent sustain period stabilizes.

The reason why the width of the scan pulse is set to be the first critical time or more in a subfield embodying a low gray level due to a relatively low weight is that the number of sustain pulses in a subfields embodying a low gray level due to the relatively low weight is fewer than that of other subfields embodying a high gray level. Accordingly, the amount of wall charges stacked within the discharge cells is less and thus because there is a possibility that the sustain discharge will become unstable, a stable address discharge in the address period is generated by setting the width of the scan pulse to be wider than that of other subfields and thus distribution of wall charges within the discharge cells is set to be more advantageous in the sustain discharge.

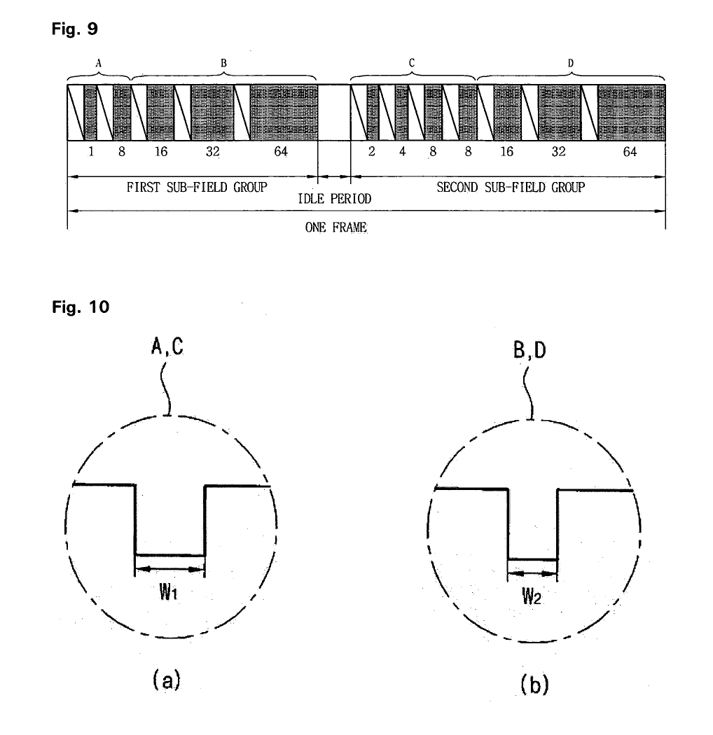

FIG. 8 shows a case where the number of the subfields adjusting the width of the scan pulse applied to the scan electrode in the address period to be the first critical time or more is one, but the width of the scan pulse applied to the scan electrode in the address period of a plurality of subfields within a subfield group may be adjusted to be the first critical time or more. The driving method is shown in FIG. 9.

FIG. 9 is a diagram illustrating an example in which one frame is divided into a plurality of subfield groups and in which subfield groups are selected.

As shown in FIG. 9, when one frame is divided into two subfield groups, that is, the first subfield group and the second subfield group as in FIG. 8, a plurality of subfield groups are selected and the width of the scan pulse applied to the scan electrode in the address period in the selected subfield is wider than that of other subfields. The width of the scan pulse is set to be the first critical time or more. As a result, the subfield in which the width of the scan pulse is adjusted to be the first critical time or more is plural within each subfield group.

The width of the scan pulse in such a driving method will be described with reference to FIG. 10.

FIG. 10 is a diagram illustrating the width of a scan pulse according to the first embodiment of a method of driving a plasma display panel of the present invention.

Referring to FIG. 10, as in FIG. 9, the width of the scan pulse applied to the scan electrode in the address period of the subfield in A area of the first subfield group and C area of the second subfield group is wider than that of the scan pulse applied to the scan electrode in the address period of the subfield in the B area of the first subfield group and the D area of the second subfield group. For example, as in (a) of FIG. 10, if the width of the scan pulse applied to the scan electrode in the address period of the subfield in A area of the first subfield group and C area of the second subfield group is W1 and the width of the scan pulse applied to the scan electrode in the address period of the subfield in B area of the first subfield group and D area of the second subfield group is W2, W1 is wider than W2. As describe above, subfields in which the width of the scan pulse applied to the scan electrode in the address period is wider than that of other subfields with a low weight/low gray level within the subfield groups.

Subfields in which the width of the scan pulse applied to the scan electrode in the address period is wider than that of other subfields can included in the same number within each subfield group, that is, the first subfield group and the second subfield group. For example, the width of the scan pulse applied to the scan electrode in the address period in each of the three subfields within the first subfield group and the second subfield group is wider than that of other subfields.

Subfields in which the width of the scan pulse applied to the scan electrode in the address period is wider than that of other subfields may be included in only one group among the first subfield group or the second subfield group and may not be included in other subfield groups.

Subfields in which the width of the scan pulse applied to the scan electrode in the address period is wider than other subfields can be included in a different number within subfield groups, that is, the first subfield group and the second subfield group. For example, the width of the scan pulse applied to the scan electrode in the address period in two subfields in the first subfield group and four subfields in the second subfield group can be wider than that of other subfields.

Preferably, as describe above, the width of the scan pulse is adjusted to be the first critical time or more in the subfield in which the width of the scan pulse applied to the scan electrode in the address period is wider than that of other subfields. Preferably, subfields in which the width of the scan pulse applied to the scan electrode in the address period is adjusted to be the first critical time or more are subfields from a subfield having the lowest gray level value to the predetermined number of subfield in the size order of a weight/gray level value.

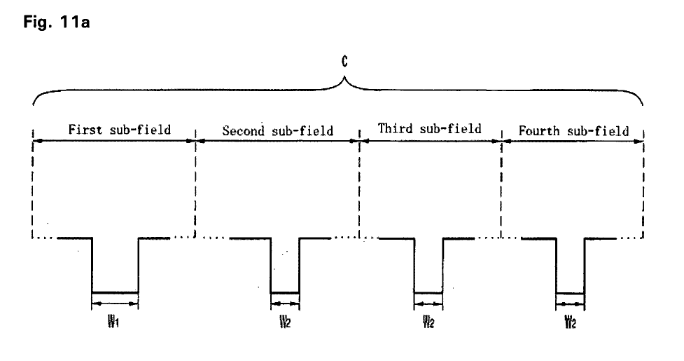

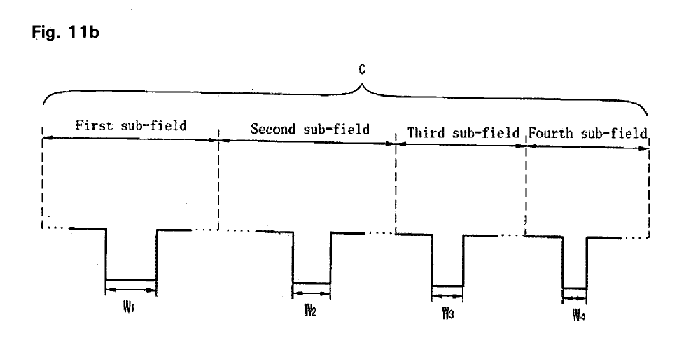

The relationship of the width of the scan pulse between subfields adjusting the width of the scan pulse applied to the scan electrode in the address period to be the first critical time or more is shown in FIG. 11a and 11b.

FIGS. 11a to 11b are diagrams illustrating the relationship of the width of a scan pulse between subfields adjusting the width of the scan pulse applied to the scan electrode in the address period to be a first critical time or more.

Referring to FIG. 11a, as in C area of the second subfield shown in FIG. 9, when the width of the scan pulse applied to the scan electrode in the address period in four subfields is wider than that of other subfields, that is, when the width of the scan pulse applied to the scan electrode in the address period in the first, second, third, fourth subfields is made to be wider than that of other subfields, the width of the scan pulse applied to the scan electrode in the address period in the first, second, third, fourth subfields is adjusted to be the first critical time or more. Further, the width of the scan pulse of any one subfield among subfields in which the width of the scan pulse is adjusted to be the first critical time or more is wider than that of the scan pulses of other subfields.

It is preferable that a subfield having a scan pulse with significantly wider pulse width among subfields in which the width of the scan pulse within one subfield group is the first critical time or more has the lowest weight, that is, the lowest gray level value within one subfield group.

For example, as shown in FIG. 11a, if the pulse width of the first subfield having the lowest weight/lowest gray level value in the first, second, third, fourth subfields in which the width of the scan pulse in the second subfield group is the first critical time or more is W1 and the scan pulse width of the remaining subfields, that is, the second, third, fourth subfields is W2, W1 is wider than W2.

Referring to FIG. 11b, the widths of the scan pulses applied to the scan electrode in the address period in the subfields in which the scan pulse has the width of the first critical time or more within one subfield group are different from each other.

For example, as in FIG. 11b, the widths of the scan pulses in the first subfield, the second subfield, the third subfield, and the fourth subfield are different from each other in the first, second, third, fourth subfields in which the width of the scan pulse in the second subfield group is the first critical time or more. For example, if the width of the scan pulse in the first subfield is W1, the width of the scan pulse in the second subfield is W2, the width of the scan pulse in the third subfield is W3, and the width of the scan pulse in the fourth subfield is W4, W1, W2, W3, and W4 are different from each other and the value thereof is determined depending on the weight/the gray level value of corresponding subfield. That is, as in FIG. 11b, the width W1 of the scan pulse in the first subfield having the lowest weight is widest, the next widest one is W2, the next widest one is W3, and the next widest one is W4 in the size order of the weight/the gray level value in the first, second, third, fourth subfields. A relationship of W1>W2>W3>W4 is obtained.

The subfield in which the width of the scan pulse is adjusted to be the first critical time or more can be determined in a viewpoint of the number of the sustain pulse in the sustain period. In order words, a subfield having few sustain pulse is a subfield embodying a low weight/low gray level and a subfield having many sustain pulses is a subfield embodying a high weight/high gray level. Because the weight/gray level of the subfield depends on the number of the sustain pulses, a reference selecting a subfield in which the width of the scan pulse applied to the scan electrode in the address period is adjusted to be the first critical time or more is set by the critical number of the sustain pulse and the width of the scan pulse is adjusted to be the first critical time or more in a subfield having sustain pulses fewer than the critical number of the-set sustain pulse.

Preferably, the critical number is 50% or less than the total sustain pulses used in one frame. More preferably, the critical number is 30% or less than the total sustain pulses used in one frame.

For example, when 1000 total sustain pulses are used in one frame, a subfield using sustain pulses of 30% or less, that is, 300 sustain pulses or less than the total sustain pulses used in one frame is selected and the width of the scan pulse applied to the scan electrode in the address period in the selected subfield is adjusted to be the first critical time or more.

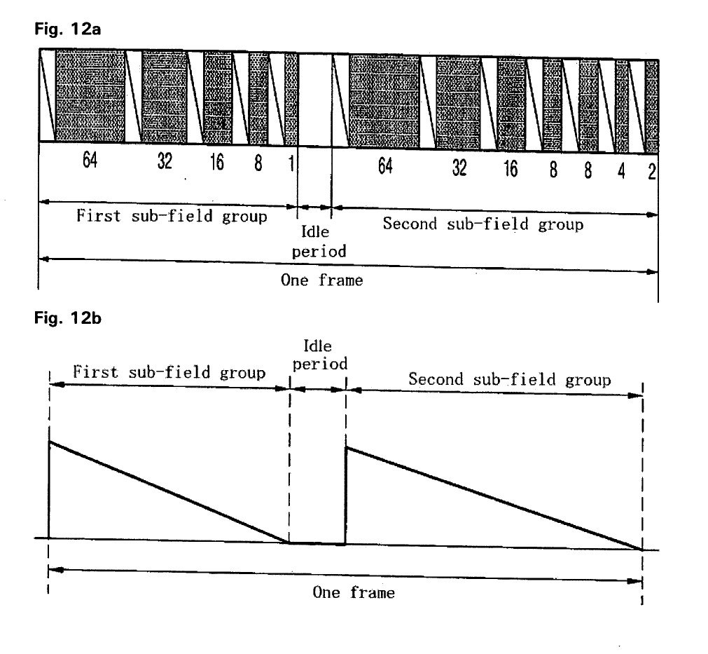

In the above description, subfields are arranged in the increasing order of weight within a subfield group of one frame as shown in FIG. 7a and 7b, but subfields may be arranged in the decreasing order of weight and this is shown in FIGS. 12a and 12b.

FIGS. 12a and 12b are diagrams illustrating another example in which one frame is divided into a plurality of subfield groups.

As shown in FIGS. 12a and 12b, one frame is divided into a plurality of subfield groups and subfields are arranged in the decreasing order of weight, that is, a gray level value within each subfield group.

For example, as shown in FIG. 12a, subfields are arranged in the decreasing order of weight, that is, a gray level value within each group, that is, a first subfield group and a second subfield. A subfield embodying the highest gray level highest weight is positioned at an initial position of each subfield group, that is, the first subfield group or the second subfield group and then subfields having a gradually lower weight/low gray level value are positioned.

For example, a subfield of weight 64, a subfield of weight 32, a subfield of weight 16, a subfield of weight 8, and a subfield of weight 1 are included in the order in the first subfield group.

A subfield of weight 64, a subfield of weight 32, a subfield of weight 16, two subfields of weight 8, a subfield of weight 4, and a subfield of weight 2 are included in order in the second subfield group. A concept of an idle period and a concept of a weight of the subfield in one frame are shown in FIG. 12b.

Referring to FIG. 12b, two subfield groups, that is, the first subfield group and the second subfield group are included in one frame and an idle period is included between these subfield groups. It is important that the weight of the subfield included in each subfield group shows a triangle shape. The triangle shape indicates that subfields are arranged in the decreasing order of a weight, that is, a gray level value within each subfield.

An idle period having a predetermined length is further included between the first subfield group and the second subfield group.

As shown in FIG. 12a, a sum of the weights of subfields within one frame is 1+2+4+8+(8+8)+(16+16)+(32+32)+(64+64)=255.

Subfields having the weights of 1, 2, 4, 8, 16, 32, 64, 128 are arranged in the reverse order of gray level values and thus a total gray level value, that is, a total gray level can embody the same 256 gray levels as that of the frame shown in FIG. 2. Further, an effect of two frame embodying gray levels of 121 and 135 including the second subfield group which can embody 121 gray levels and the first subfield group which can embody 135 gray levels can be obtained. Accordingly, flicker is reduced.

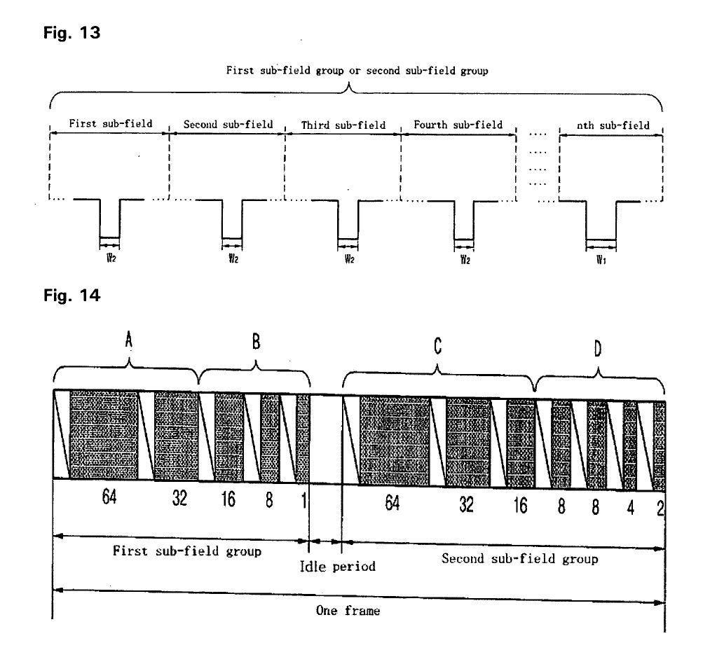

In a mode in which one frame is driven by dividing into a plurality of subfield groups, the width of the scan pulse is adjusted in any one subfield having the low weight/low gray level. The scan pulse adjusted according to such a driving method is shown in FIG. 13.

FIG. 13 is a diagram illustrating a driving waveform according to a second embodiment of a method of driving a plasma display panel of the present invention.

As shown in FIG. 13, in the second embodiment of the method of driving the plasma display panel of the present invention, the width of the scan pulse applied to the scan electrode in an address period of a last subfield, that is, the nth subfield is wider than that of other subfields.

For example, as shown in FIG. 13, if the width of the scan pulse applied to the scan electrode in the address period in a subfield, that is, the nth subfield having a low weight/low gray level value within the first subfield group or the second subfield group is W1 and the width of the scan pulse in other subfields, that is, from the first subfield to the n-1 subfield is W2, W1 is wider than W2.

As describe above, in a subfield, that is, the nth subfield shown in FIG. 13 in which the width of the scan pulse applied to the scan electrode (Y1 to Yn) in the address period is wider than that of other subfields, the width of the scan pulse, that is, W1 has a width of the first critical time or more.

In the remaining subfields, that is, subfields from the first subfield to the n-1th subfield except the subfield in which the width of the scan pulse applied to the scan electrode (Y1 to Yn) in the address period is the first critical time or more, the width, that is, W2 of the scan pulse applied to the scan electrode (Y1 to Yn) in the address period has a width of the second critical time or less.

Preferably, the second critical time is 1.5 μs as in the first embodiment of the method of driving the plasma display panel of the present invention and thus W2 is 1.5 μs or less. In FIG. 13, in a subfield having the lowest weight within the first subfield group or the second subfield group, that is, a last subfield of each subfield group, the width of the scan pulse applied to the scan electrode in the address period in the remaining subfields except the nth subfield of, for example, the second subfield group is 1.5 μs or less.

Preferably, the subfield in which the width of the scan pulse applied to the scan electrode in the address period in each subfield group, that is, the first subfield group and the second subfield group is the first critical time or more is a subfield embodying a low gray level/low weight. The description on FIG. 13 is substantially equal with that of FIG. 8 of the first embodiment in the method of driving the plasma display panel of the present invention and thus description thereof will be omitted.

FIG. 13 illustrates only a situation where the number of the subfields in which the width of the scan pulse applied to the scan electrode in the address period is adjusted to be the first critical time or more is one, but explained 1 individual cases, but it is possible to adjust the width of the scan pulse applied to the scan electrode in the address period of a plurality of subfields within the subfield group to be the first critical time or more. The driving method is shown in FIG. 14.

FIG. 14 is a diagram illustrating another example in which one frame is divided into a plurality of subfield groups and a subfield group is selected.

As shown in FIG. 14, in another example in which one frame is divided into a plurality of subfield groups and a subfield group is selected, differently from the case shown in FIG. 9, because a subfield having the low weight/low gray level is positioned in the rear end of a subfield group, the width of the scan pulse of the rear subfield of subfield groups, that is, a subfield of B area of the first subfield group and D area of the second subfield group is made to be wider than that of the scan pulse of other subfields, that is, a subfield of A area of the first subfield group and C area of the second subfield group. The width of the scan pulse of the subfield of B area of the first subfield group and D area of the second subfield group is set to the first critical time or more.

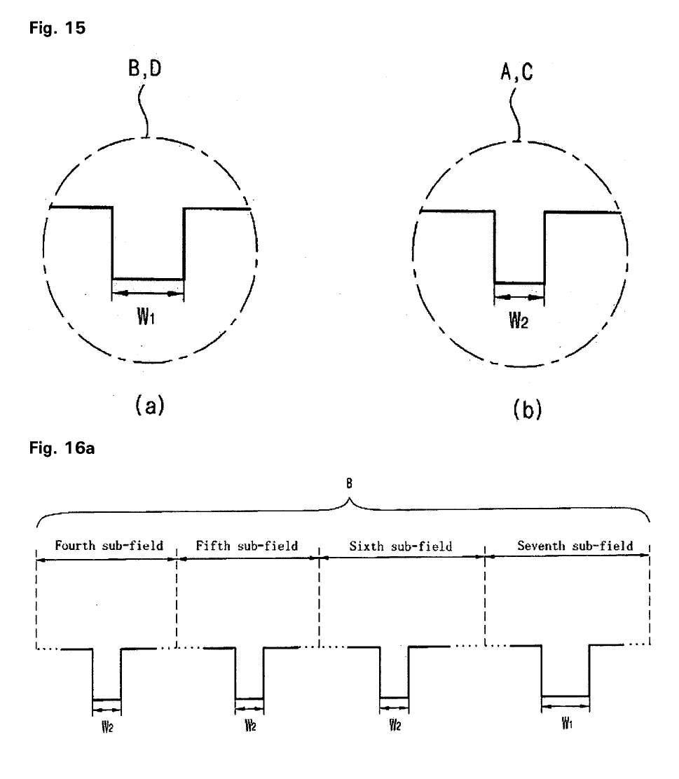

The width of the scan pulse in such a driving method will be described with reference to FIG. 15.

FIG. 15 is a diagram illustrating a width of a scan pulse according to the second embodiment of the method of driving a plasma display panel of the present invention.

Referring to FIG. 15, as shown in FIG. 14, the width of the scan pulse applied to the scan electrode in the address period of the subfield of B area of the first subfield group and D area of the second subfield group is wider than that of the scan pulse applied to the scan electrode in the address period of the subfield of other areas, that is, A area of the first subfield group and C area of the second subfield group. For example, as in (a) of FIG. 10, if the width of the scan pulse applied to the scan electrode in the address period of the subfield of B area of the first subfield group and D area of the second subfield group is W1 and the width of the scan pulse applied to the scan electrode in the address period of the subfield in A area of the first subfield group and C area of the second subfield group is W2, W1 is wider than W2. As described above, subfields in which the width of the scan pulse applied to the scan electrode in the address period is wider than that of other subfields within a subfield group are subfields having a low weight/low gray level value.

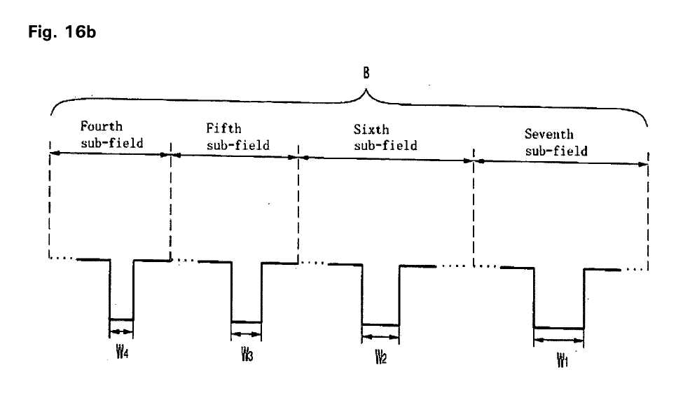

As describe above, subfields in which the width of the scan pulse applied to the scan electrode in the address period is wider than that of other subfields are plural within one subfield group and the relationship of the width of the scan pulse between subfields adjusting the width of the scan pulse applied to the scan electrode in the address period to be wider than the first critical time is shown in FIGS. 16a to 16b.

FIGS. 16a to 16b are diagrams illustrating another relationship of the width of a scan pulse between subfields adjusting a width of a scan pulse applied to a scan electrode in an address period to be a first critical time or more.

Referring to FIG. 16a, as in B area of the first subfield shown in FIG. 14, when the width of the scan pulse applied to the scan electrode in the address period in four subfields is wider than that of other subfields, that is, when the width of the scan pulse applied to the scan electrode in the address period of the third, fourth, fifth subfields within the first subfield group is wider than that of other subfields, the width of the scan pulse applied to the scan electrode in the address period of these subfields, that is, the third, fourth, fifth subfields is adjusted to be the first critical time or more. Further, the width of the scan pulse of any one subfield among the subfields in which the width of the scan pulse is adjusted to be the first critical time or more is wider than that of the remaining subfields.

Preferably, the subfield having a significantly wider pulse width among subfields in which the scan pulse within one subfield group has a width of the first critical time or more is the subfield having the lowest weight/lowest gray level value within one subfield group.

For example, as in FIG. 16a, if the pulse width of the seventh subfield having the lowest weight/gray level value in the fourth, fifth, sixth, seventh subfields in which the width of the scan pulse in the second subfield group is the first critical time or more is W1 and the pulse width of the remaining subfields, that is, the fourth, fifth, and sixth subfields is W2, W1 is wider than W2.

Referring to FIG. 16b, the widths of the scan pulses applied to the scan electrode in the address period in subfields in which the scan pulse has the width of the first critical time or more within one subfield group are different from each other.

For example, as in FIG. 16b, in the fourth, fifth, sixth, and seventh subfields in which the width of the scan pulse is the first critical time or more in the first subfield group, the width of the scan pulse in the fourth subfield, the width of the scan pulse in the fifth subfield, the width of the scan pulse in the sixth subfield, and the width of the scan pulse in the seventh subfield are different. For example, if the width of the scan pulse in the seventh subfield width is W1, the width of the scan pulse in the sixth subfield is W2, the width of the scan pulse in the fifth subfield is W3, and the width of the scan pulse in the fourth subfield is W4, W1, W2, W3, and W4 are different from each other and the size thereof is determined depending on the weight/gray level value of corresponding subfield. In FIG. 16b, in the size order of the weight/gray level value of the fourth, fifth, sixth, and seventh subfields, the width W1 of the scan pulse in the seventh subfield having the lowest weight is widest, the next widest one is W2, the next widest one is W3, and the next widest one is W4. A relationship of W1>W2>W3>W4 is obtained.

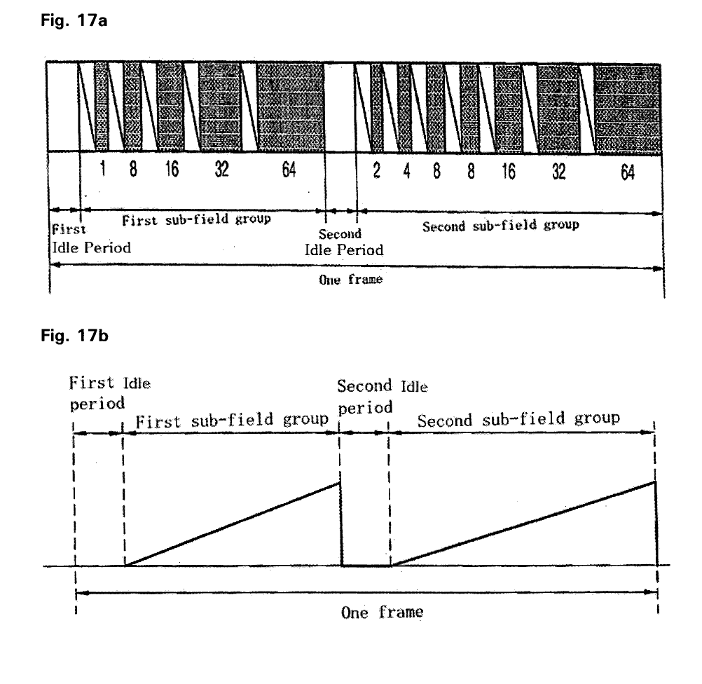

As described above, one frame is divided into a plurality of subfield groups and one idle period is included between the divided plurality of subfield groups, but an idle period having a predetermined length may be further included between subfield groups and between frames. Such a driving method is shown in FIGS. 17a and 17b.

FIGS. 17a to 17b are diagrams illustrating a third embodiment of the method of driving the plasma display panel of the present invention.

Referring to FIGS. 17a and 17b, the first idle period having a predetermined length is included at a front end of the frame and the second idle period having a predetermined length is also included between the first subfield group and the second subfield group.

Referring to FIG. 17a, subfields of one frame are divided into a plurality of subfield groups, preferably, two subfield groups, that is, the first subfield group and the second subfield group and arranged by the increasing order of weight/gray level value within these subfield groups. A subfield having the lowest weight/lowest gray level value is positioned at an initial position within each subfield group and subfields having gradually higher weights are then positioned. For example, a subfield of weight 1/gray level value 1, a subfield of weight 8, a subfield of weight 16, a subfield of weight 32, and a subfield of weight 64 are included in the order in the first subfield group.

Further, a subfield of weight 2, that is, gray level value 2, a subfield of weight 4, two subfields of weight 8, a subfield of weight 16, a subfield of weight 32, and a subfield of weight 64 are included in the order in the second subfield group.

As described above, the second idle period having a predetermined length is included between subfield groups and the first idle period having a predetermined length between frames is included. The lengths of the first idle period and the second idle period may be different or equal. However, preferably, considering a visual division effect and easiness of a driving control between subfield groups, lengths of the first idle period and the second idle period should be equal.

A visual effect recognizing one frame into two frames increases due to the first idle period between frames and the second idle period between subfield groups. Accordingly, flicker decreases and image quality improves. The third embodiment according to a method of driving the plasma display panel of the present invention is substantially equal with the first embodiment shown in FIGS. 7a and 7b and thus descriptions thereof will be omitted.

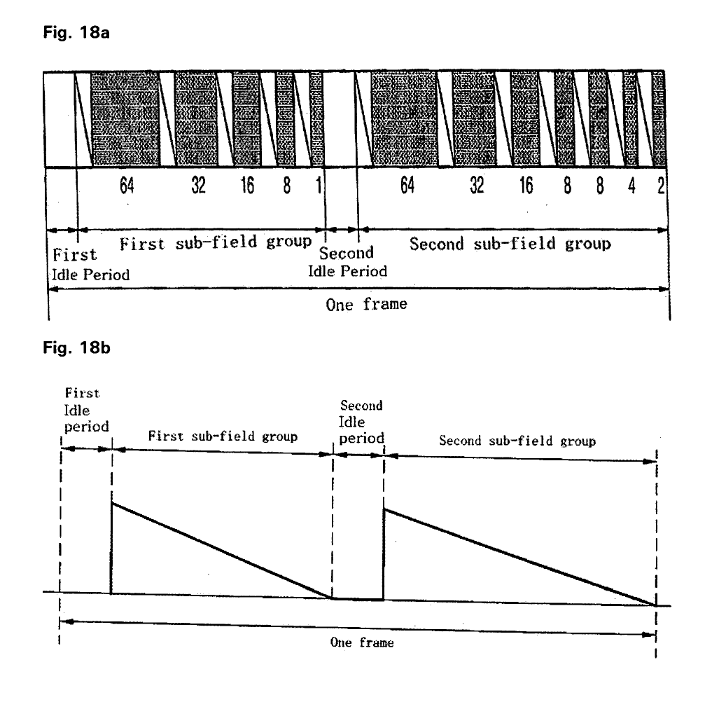

Differently from the third embodiment according to the method of driving the plasma display panel of the present invention, subfields can be arranged by the decreasing order of a weight/gray level value within each subfield group. The driving method is shown in FIG. 18a and 18b.

FIGS. 18a to 18b are diagrams illustrating a fourth embodiment of the method of driving the plasma display panel of the present invention.

As shown in FIGS. 18a and 18b, in the fourth embodiment of the method of driving the plasma display panel of the present invention, subfields are arranged within subfield groups by decreasing order of a weight/gray level value.

The fourth embodiment of the present invention is substantially equal with the second embodiment of a method driving of the plasma display panel according to the present invention shown in FIG. 12a or 12b and thus descriptions thereof will be omitted.

The invention being thus described, may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus displaying an image in a frame having a plurality of subfield groups, the plasma display apparatus comprising:
a plasma display panel comprising a scan electrode and
a scan pulse controller for controlling a width of a scan pulse applied to the scan electrode in address period of a predetermined subfield of the subfield group to be wider than the width of a scan pulse of other subfield in the frame.

2. The plasma display apparatus of claim 1, wherein an idle period having a predetermined length is included between frames and subfield groups of the frame is continuously arranged within the same frame.

3. The plasma display apparatus of claim 1, wherein a first idle period having a predetermined length is included between frames and a second idle period having a predetermined length is further included between the subfield groups within the same frame.

4. The plasma display apparatus of claim 3, wherein lengths of the first idle period and the second idle period are the same.

5. The plasma display apparatus of any one of claims 1 to 3, wherein the plurality of subfield groups include a plurality of subfields and the plurality of subfield groups are arranged in the increasing order of a gray level value of subfields within each group.

6. The plasma display apparatus of any one of claims 1 to 3, wherein the plurality of subfield groups include a plurality of subfields and the plurality of subfield groups are arranged in the decreasing order of a gray level value of subfields within each group.

7. The plasma display apparatus of any one of claims 1 to 3, wherein the frame is divided into two subfield groups, each of two subfield groups includes a plurality of subfields, the two subfield groups are arranged in the size order of a different gray level value of subfields within each subfield group.

8. The plasma display apparatus of claim 7, wherein any one of the two subfield groups is arranged in the increasing order of a gray level value of subfields within each group.

9. The plasma display apparatus of claim 7, wherein any one of the two subfield groups is arranged in the decreasing order of a gray level value of subfields within each group.

10. The plasma display apparatus of claim 7, wherein any one of the two subfield groups is arranged in the decreasing order of a gray level value of subfields within each group and the other one of the two subfield groups is arranged in the increasing order of a gray level value of subfields within each group.

11. The plasma display apparatus of claim 1, wherein the scan pulse controller sets the width of a scan pulse to be a first critical time or more in a subfield in which a width of the scan pulse applied to the scan electrode is wider than the width of the scan pulse of other subfield in the address period.

12. The plasma display apparatus of claim 11, wherein the first critical time is 2.0 μs.

13. The plasma display apparatus of claim 11, wherein the width of a scan pulse applied to the scan electrode in the address period in one and more subfield is equal to or more than the first critical time.

14. The plasma display apparatus of claim 11, wherein the width of a scan pulse applied to the scan electrode in the address period in one and more subfield in each subfield group is equal to or more than the first critical time.

15. The plasma display apparatus of claim 11, wherein the width of a scan pulse applied to the scan electrode in the address period is equal to or more than the first critical time in subfields from the lowest gray level subfield to a predetermined number of subfields in ascending order of a gray level.

16. The plasma display apparatus of claim 15, wherein the width of a scan pulse applied to the scan electrode in any subfield of three low gray level subfields is wider than the width of a scan pulse applied to the scan electrode other subfields.

17. The plasma display apparatus of claim 11, wherein the subfield are plural in which the width of the scan pulse is equal to or more than the first critical time,
the scan pulse controller sets a width of the scan pulse applied to the scan electrode in the address period of one subfield of the plurality of subfields to be different from a width of the scan pulse applied to the scan electrode in the address period of other subfields of the plurality of subfields

18. The plasma display apparatus of claim 11, wherein the subfield are plural in which the width of the scan pulse is equal to or more than the first critical time,
the scan pulse controller sets a width of the scan pulse applied to the scan electrode in the address period to be different from a width of the scan pulse applied to the scan electrode in the address period of each subfield of the plurality of subfields

19. The plasma display apparatus of claim 18, wherein the scan pulse controller increases a width of a scan pulse applied to the scan electrode in the address period as a gray level in any subfield of the plurality of subfields decreases.

20. The plasma display apparatus of any one of claims 11 to 19, wherein the subfield in which the width of the scan pulse is equal to or more than the first critical time uses sustain pulses equal to or less than the critical number.

21. The plasma display apparatus of claim 20, wherein the critical number is 50% or less than the number of total sustain pulses used in one frame.

22. The plasma display apparatus of claim 21, wherein the critical number is 30% or less than the number of total sustain pulses used in one frame.

23. The plasma display apparatus of claim 11, wherein the scan pulse controller sets the width of the scan pulse applied to the scan electrode in the address period to be the second critical time or less in the other subfield except a subfield in which the width of the scan pulse applied to the scan electrode in the address period is the first critical time or more.

24. The plasma display apparatus of claim 23, wherein the second critical time is ½ of the first critical time.

25. The plasma display apparatus of claim 23, wherein the second critical time is 1.5 μs.

26. A driving apparatus of a plasma display panel displaying an image in a frame having a plurality of subfield groups, the driving apparatus of a plasma display panel comprising:
a scan driver for applying scan pulse to a scan electrode; and
a scan pulse controller for controlling a width of a scan pulse applied to the scan electrode in address period of a predetermined subfield of the subfield group to be wider than the width of a scan pulse of other subfield in the frame.

27. A plasma display panel displaying an image in a frame having a plurality of subfield groups, the plasma display panel comprising:
a scan electrode and a sustain electrode,
wherein a width of a scan pulse applied to the scan electrode in address period of a predetermined subfield of the subfield group is wider than the width of a scan pulse of other subfield in the frame.

28. A method of driving a plasma display apparatus displaying an image in a frame having a plurality of subfield groups, the method comprising:
setting a width of a scan pulse applied to the scan electrode in address period of a predetermined subfield of the subfield group to be wider than the width of a scan pulse of other subfield in the frame.
